(19) United States
(12) Patent Application Publication
(10) Pub. No.: US 2019/0289767 A1
(43) Pub. Date: Sep. 26, 2019

(54) Modular Agricultural Apparatus and Methods of Using the Same

(71) Applicant: Timothy Gulotta, Kirkland, IL (US)

(72) Inventor: Timothy Gulotta, Kirkland, IL (US)

(21) Appl. No.: 16/359,025

(22) Filed: Mar. 20, 2019

Related U.S. Application Data
(60) Provisional application No. 62/646,742, filed on Mar. 22, 2018.

(51) Int. Cl. A01B 49/06; A01C 5/06

(52) U.S. Cl. CPC A01B 49/06; A01B 63/16; A01C 5/064

(57) ABSTRACT

Modular agricultural apparatus for management and maintenance of cover crops and cash crops aid in side-by-side banded or zonal farming. For example, the present invention relates to apparatus for seeding crops and/or suppressing or terminating cover crops while offering option to manage cash crops. Specifically, the agricultural apparatus comprises a plurality of sections, each having a tool for either seeding crops or terminating cover crops in a band configuration. Therefore, management of cash crops and cover crops may be more easily maintained and managed. Methods of using the same to manage and maintain cash crops while seeding and/or terminating cover crops are further provided.

The present invention claims priority to U.S. Provisional Pat. App. No. 62/646,742, titled “Modular Agricultural Apparatus and Methods of Using the Same,” filed Mar. 22, 2018, which is incorporated herein by reference in its entirety.

### TECHNICAL FIELD

The present invention relates to a modular agricultural apparatus for management and maintenance of cover crops and cash crops in side-by-side banded or zonal farming. For example, the present invention relates to apparatus for seeding cover crops and/or suppressing or terminating cover crops while offering option to manage cash crops. Specifically, the agricultural apparatus comprises a plurality of sections, each having a tool for either seeding crops or terminating cover crops in a band configuration. Therefore, management of cash crops and cover crops may be more easily maintained and managed. Methods of using the same to manage and maintain cash crops while seeding and/or terminating cover crops are further provided.

### BACKGROUND

A “cover crop” is a crop planted on a tract of land primarily to provide certain benefits to a desired harvestable crop, known as a “cash crop.” Specifically, certain advantages can include the management of soil erosion, soil fertility, soil quality, water, weeds, pests, diseases, biodiversity and wildlife in an agroecosystem. Cover cropping methods have been phased in and out of agricultural systems. Many countries are trying to adapt methods of planting cover crops with cash crops, but there are many difficulties associated with this agricultural method, despite the significant advantages.

Cover crops are of interest in regenerative agriculture as many of them improve the sustainability of agroecosystem attributes and may also indirectly improve qualities of neighboring natural ecosystems. Farmers choose to grow and manage specific cover crop types based on their own needs and goals, influenced by the biological, environmental, social, cultural, and economic factors of the food system in which they operate. Agronomy research is beginning to take a close look at cost/benefit analyses and particular growing methods, in order to address practical concerns of growers. Although the practice is not currently wide-spread, it is gaining traction.

A cover crop is typically planted on a tract of land either before, during or after a desired so-called cash crop is planted. However, integrating a cover crop into an agricultural system has challenges. Cover crops in most typical systems are seeded over the entirety of the field requiring management practices prior to planting the cash crop, namely the elimination of the entirety of the cover crop prior to planting. Elimination practices include tillage, crimping or herbicides just prior to or at the same time as planting a cash crop. However, this may lead to termination of a cover crop prematurely, prior to obtaining the benefits for which the cover crop had been planted. For example, cover crops may be utilized to fix nutrients in the soil for the cash crop, to prevent erosion, to provide cover to prevent the growth of weeds, and for other purposes. If a cover crop is not maintained long enough, some or all of these benefits may not be realized. However, if a cover crop is maintained too long, it may be difficult for proper seeding of the cash crop at the optimal time, as root systems and top growth of the cover crop may interfere with the cash crop planting process.

One solution is to plant cover crops and cash crops in rows next to each other in a process called “banding.” Banding allows cover crops and cash crops to be grown side-by-side, and often the cash crop can obtain numerous benefits when a cover crop is grown adjacently. However, it may be difficult to manage banding, where cover crops and cash crops are planted and grown side-by-side. Oftentimes, a cover crop is not grown at the same time as a cash crop. Their life cycles are offset from one another. For example, it is often desired to start a cover crop earlier in the season, prior to the planting and growing of a cash crop. This allows the cover crop to take root in its bands, providing benefits to the soon-to-be planted cash crop, such as nutrient fixing, erosion control and weed control, to name a few. While maintaining barren bands in anticipation of planting cash crops may be ideal due to the lack of cover crop root systems and top growth in the barren bands, it is often difficult to manage the planting of both cover crops and cash crops in the bands, especially when they are planted and grown at different times of the year.

Moreover, it is often desirable to terminate a cover crop when its objective has been achieved, oftentimes prior to harvesting the cash crop. This may provide additional benefits, such as providing nutrient availability that improves yield, increasing biomass for weed suppression, or timely release of allelopathic chemicals for weed suppression. Again, it is typically difficult to mechanically terminate a cover crop while a cash crop continues to grow in the same field. Oftentimes, cash crops are inadvertently sacrificed when terminating the cover crop.

In addition, it may further be desirable to merely suppress a cover crop and not terminate it while the cash crop is growing. This may prolong the particular benefits during the entirety of the cash crop growing season. In addition, cover crops are often planted and grown after the harvesting of a cash crop, and by suppressing the cover crop, the cover crop may be maintained and grown after the harvest of the cash crop, thereby providing the benefit without requiring replanting of the cover crop.

Agronomic plans are always contingent. Weather events cause farmers to constantly adjust their planting and growing plans. Because of this, biological benefits of cover crops vary from year to year. By planting in bands, there can be great flexibility in planting both the cover crops and the cash crops. For example, planting in barren strips prior to cover crop suppression allows the cash crop to be planted at an earlier date potentially improving yield. Delaying cover crop suppression or termination has numerous biological benefits. Specifically, allowing the cover crop to continue to grow improves the probability of fixing nutrients in the soil and suppressing weeds and erosion. Delayed suppression also provides the added benefit of nutrient availability later in the growing season, as noted above. As cover crops decompose, nutrients leach into the soil that are available to the cash crop. If this can be timed later in the season, the nutrients may be better utilized by the cash crop. Moreover, below the surface, cover crop root activity can translocate nutrients in the root zone of the cash crop. Root systems that are terminated in a timely fashion create an underground root relay effect where the translocated nutrients shift from cover crop to cash crop. Cover crops grown in bands also provide the opportunity for a variety of different cover crop species to grow together as sunlight has the opportunity to reach all plants.

Cover crops may also be useful in other ways. For example, instead of termination, cover crops may be harvested for seeds, used as feed material for livestock, or for selling the same. In addition, if the cash crop fails, cover crops may be harvested instead, offsetting losses.

Banded arrangements of cash crops and cover crops also decrease the use other traditional techniques, such as spraying of herbicides or application of fertilizers. Cover crops may be specifically selected for these purposes, rendering other management techniques unnecessary, but banding cash crops and cover crops decreases the area to which these other management techniques are necessary. Thus, banded crop arrangements may lead to decreases in materials needed for the other management techniques and increases in application speed (due to less cash crop volume).

Traditional agricultural tools and apparatuses are not often designed with cover crops and cash crops in a banded arrangement. The traditional tools and apparatuses often do not provide the ability to manage both the cover crop and the cash crop at the same time. Often, separate specialized equipment must be used by farmers to manage cover crops and cash crops individually. In addition, typical agricultural tools are not designed to manage rows of cover crop and cash crop at the same time. Specifically, typical agricultural tools are designed to manage either the cover crop or the cash crop, but not both. Therefore, often maintaining of management of the cash crop must be done separately from the cover crop.

Moreover, the use of autonomous robots/lightweight machines that travel between or straddling rows of crops have grown in use. Their use is beneficial as they can often navigate in agricultural fields when larger tractors cannot due to their smaller size and weight. However, their smaller size and footprint can lead to traction issues, and robots often find it difficult to traverse saturated or muddy ground. While autonomous robots lightweight machines have been used primarily for management of cash crops, the robots and machines are typically not utilized to provide cover crop and/or cash crop actions.

A need, therefore, exists for improved agricultural apparatuses and methods of using the same for improved management of crops. More specifically, a need exists for improved agricultural apparatuses and methods of using the same allowing for relatively easy and efficient management of cover crops and cash crops on a tract of land.

In addition, a need exists for improved agricultural apparatuses and methods of using the same that allow for both planting of cash crops and suppression or mechanical termination of cover crops in a field at the same time. Moreover, a need exists for improved agricultural apparatuses and methods of using the same that increase flexibility in the planting, suppression and/or termination of cover crops before, during or after the planting and harvesting of a cash crop.

Further, a need exists for improved agricultural apparatuses and methods of using the same that provides modular and swappable tools on a tow vehicle for managing rows of both cover crops and cash crops at the same time. Still further, a need exists for improved agricultural apparatuses and methods of using the same that utilize modular and swappable tools on a tow vehicle for alternately maintaining a cash crop while suppressing or terminating a cover crop.

Moreover, a need exists for improved agricultural apparatuses and methods of using the same that provides improved traction for autonomous robots and/or lightweight machines. More specifically, a need exists for improved agricultural apparatuses and methods of using the same that improves traction of mobility of autonomous robots and/or lightweight machines due to agricultural pathways formed by crimped cover crop bands within agricultural fields. Further, a need exists for improved agricultural apparatuses and methods of using the same that utilize autonomous robots and/or lightweight machines for cover crop and/or cash crop actions.

### SUMMARY OF THE INVENTION

The present invention relates to a modular agricultural apparatus for management and maintenance of cover crops and cash crops in side-by-side banded or zonal farming. For example, the present invention relates to apparatus for seeding crops and/or suppressing or terminating cover crops while offering option to manage cash crops. Specifically, the agricultural apparatus comprises a plurality of sections, each having a tool for either seeding crops or terminating cover crops in a band configuration. Therefore, management of cash crops and cover crops may be more easily maintained and managed. Methods of using the same to manage and maintain cash crops while seeding and/or terminating cover crops are further provided.

To this end, in an embodiment of the present invention, an agricultural apparatus used for managing both a cover crop and a cash crop at the same time is provided. The agricultural apparatus comprises a frame running perpendicular to a direction of travel of a tow vehicle, wherein the frame is configured to be attached to the tow vehicle when in use, the frame further comprising a first agricultural tool comprising a series of disc openers or seed coulters mounted to the frame over a first length of the frame and a second agricultural tool comprising at least one roller crimper over a second length of the frame.

In another embodiment of the present invention, an agricultural apparatus used for managing both a cover crop and a cash crop is provided. The agricultural apparatus comprises a frame running perpendicular to a direction of travel of a tow vehicle, wherein the frame is configured to be attached to the tow vehicle when in use, the frame further comprising a first agricultural tool comprising a series of releasably mounted to the frame, wherein the first agricultural tool is configured to be removed and replaced with a second agricultural tool comprising a roller crimper.

In another embodiment of the present invention, a method of using an agricultural apparatus for managing both a cover crop and a cash crop is provided. The method comprises providing a frame running perpendicular to a direction of travel of a tow vehicle, wherein the frame is configured to be attached to the tow vehicle when in use, the frame further comprising a first agricultural tool comprising a series of tools releasably mounted to the frame; removing the first agricultural tool from the frame; and disposing a second agricultural tool to the frame, wherein the second agricultural tool comprises a roller crimper.

It is, therefore, an advantage and objective of the present invention to provide improved agricultural apparatuses and methods of using the same for improved management of crops.

More specifically, it is an advantage and objective of the present invention to provide improved agricultural apparatuses and methods of using the same allowing for relatively easy and efficient management of cover crops and cash crops on a tract of land.

In addition, it is an advantage and objective of the present invention to provide improved agricultural apparatuses and methods of using the same that allow for both planting of cash crops and suppression or termination of cover crops in a field at the same time.

Moreover, it is an advantage and objective of the present invention to provide improved agricultural apparatuses and methods of using the same that increase flexibility in the planting, suppression and/or termination of cover crops before, during or after the planting and harvesting of a cash crop.

Further, it is an advantage and objective of the present invention to provide improved agricultural apparatuses and methods of using the same that provides modular and swappable tools on a tow vehicle for managing rows of both cover crops and cash crops at the same time.

Still further, it is an advantage and objective of the present invention to provide improved agricultural apparatuses and methods of using the same that utilize modular and swappable tools on a tow vehicle for alternately maintaining a cash crop while suppressing or terminating a cover crop.

Moreover, it is an advantage and objective of the present invention to provide improved agricultural apparatuses and methods of using the same that provides improved traction for autonomous robots and/or light machines.

More specifically, it is an advantage and objective of the present invention to provide improved agricultural apparatuses and methods of using the same that improves traction of mobility of autonomous robots and/or lightweight machines due to agricultural pathways formed by crimped cover crop bands within agricultural fields.

Further, it is an advantage and objective of the present invention to provide improved agricultural apparatuses and methods of using the same that utilize autonomous robots and/or lightweight machines for cover crop and/or cash crop actions.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a plan view of an exemplary frame extending from a main toolbar, typically pulled by a tractor or other agricultural apparatus, in an embodiment of the present invention.

FIG. 2 illustrates a side view of a double disc opener tool connected to an exemplary frame extending from a main toolbar in an embodiment of the present invention.

FIG. 3 illustrates a side view of a roller crimper tool connected to an exemplary frame extending from a main toolbar in an embodiment of the present invention.

FIG. 4 illustrates an end view of an autonomous robot utilizing pathways made from terminated cover crops to tend to cash crops in an embodiment of the present invention.

FIG. 5 illustrates top view of an autonomous robot utilizing pathways made from terminated cover crops to tend to cash crops in an embodiment of the present invention.

### DETAILED DESCRIPTION OF THE PRESENTLY PREFERRED EMBODIMENTS

The present invention relates to a modular agricultural apparatus for management and maintenance of cover crops and cash crops in side-by-side banded or zonal farming. For example, the present invention relates to apparatus for seeding crops and/or suppressing or terminating cover crops while offering option to manage cash crops. Specifically, the agricultural apparatus comprises a plurality of sections, each having a tool for either seeding crops or terminating cover crops in a band configuration. Therefore, management of cash crops and cover crops may be more easily maintained and managed. Methods of using the same to manage and maintain cash crops while seeding and/or terminating cover crops are further provided.

The present invention comprises an agricultural tool that effectively includes a plurality of different tools for different purposes, arranged side-by-side on a frame. The frame is attached for pushing or pulling by a tractor or other heavy machinery, over a field having alternating rows of cash crop and cover crop. Specifically, the frame runs roughly perpendicular to the direction of travel, the position of which is maintained by a triangulated connection to a center connection on the tow vehicle. The frame and the various components are easily installed or removed making the frame multipurpose. Specifically, the frame therefore has components allowing for different purposes, such as cover crop and cash crop maintenance and management at the same time when pulled by a tractor or other vehicle.

The frame has a length which may range from a few feet to many feet in length. Disposed in various positions on the frame are agricultural tools which may be easily added, removed or changed as desired. The agricultural tools may include tools for managing or terminating cover crops, including tools for seeding, roller crimpers, torches that may be utilized for terminating or managing cover crops and the like. The agricultural tools may further include tools for managing cash crops, including, for example, tools that manage cash crop weed pressure (herbicide spray nozzles and hoods, flame weed, tine weed, rotary hoe, brush weed, under cut), fertilize cash crops (brown manure, liquid, granular or pelletized), and/or prepare cash crop seedbed (tillage coulters, residue managers, cultivator sweeps).

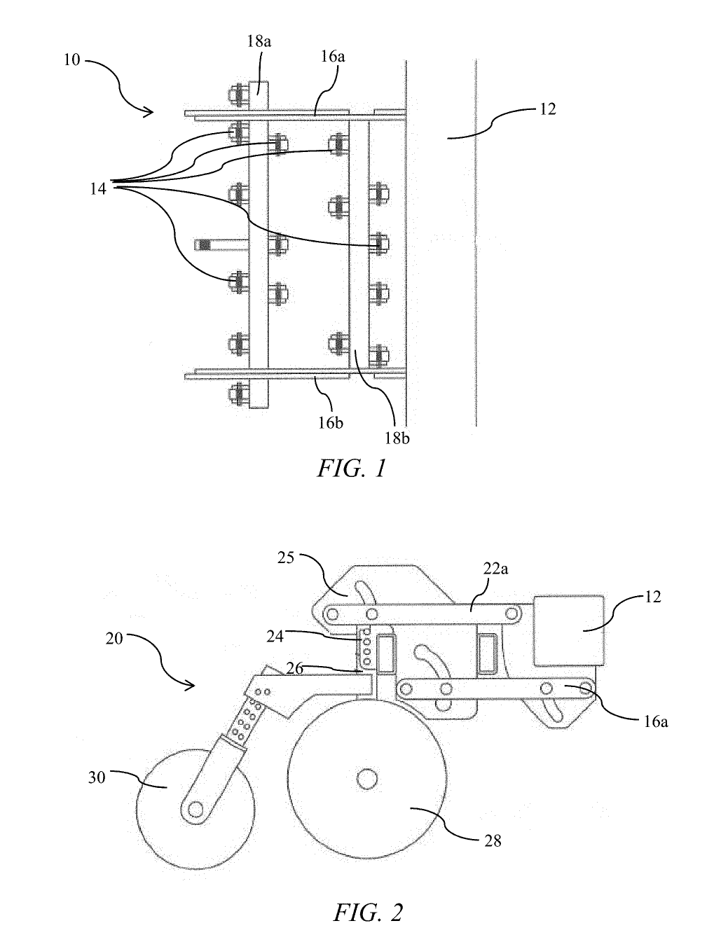

The agricultural tools may be alternately disposed along the length of the frame, depending on the desired need. FIG. 1 illustrates a plan view of an exemplary frame 10 that may be connected to and extend from a main toolbar 12 via first parallel arms 16. The frame 10 may be connected to a tractor or other like agricultural apparatus via main toolbar 12. The frame 10 may have a plurality of tool connection locations 14 disposed at various positions on the frame 10, specifically on crossbars 18 that may extend between the first parallel arms 16. The tool connection locations 14 may each comprise a connection plate 24 (shown in FIG. 2) connected to a stem 25 (shown in FIG. 2) that may be in turn connected to a tool as needed for the desired application. The various tools may be easily attached or removed and replaced, as needed. Preferably, different tools may be placed on the plurality of tool connection locations 14, based on the needs for either cash crops and cover crops disposed side-by-side.

For example, the frame 10 may contain a first agricultural tool 20 such as a V-shaped double disc opener, as illustrated in FIG. 2, for planting cover or cash crops, for fertilizing or cutting residues, or for other like purposes. This first agricultural tool 20 may be disposed in one or more tool connection locations 14 over the length of the frame 10 to manage or maintain the width of a row of the cover or cash crops in the field.

Specifically, the first agricultural tool 20 may extend from first connection plate 24 that may be attached to first crossbar 18a that, in turn, may be connected to second connection plate 25 that may be connected to both second parallel arm 22a and the first parallel arm 16a, which may extend from the main toolbar 12. Through second parallel arm 22a, slotted connection plate 24 may hold stem 26, allowing the tool, in this case a V-shaped double disc opener 28, to extend thereunder. Slots in the connection plate 24 allow the double disc opener 28 to move vertically, aligning with the contour of a field when in use. Moreover, gauge wheel 30 may further extend from the stem 26, which may further allow for the vertical movement of the double disc opener 28 to move with the contours of the field.

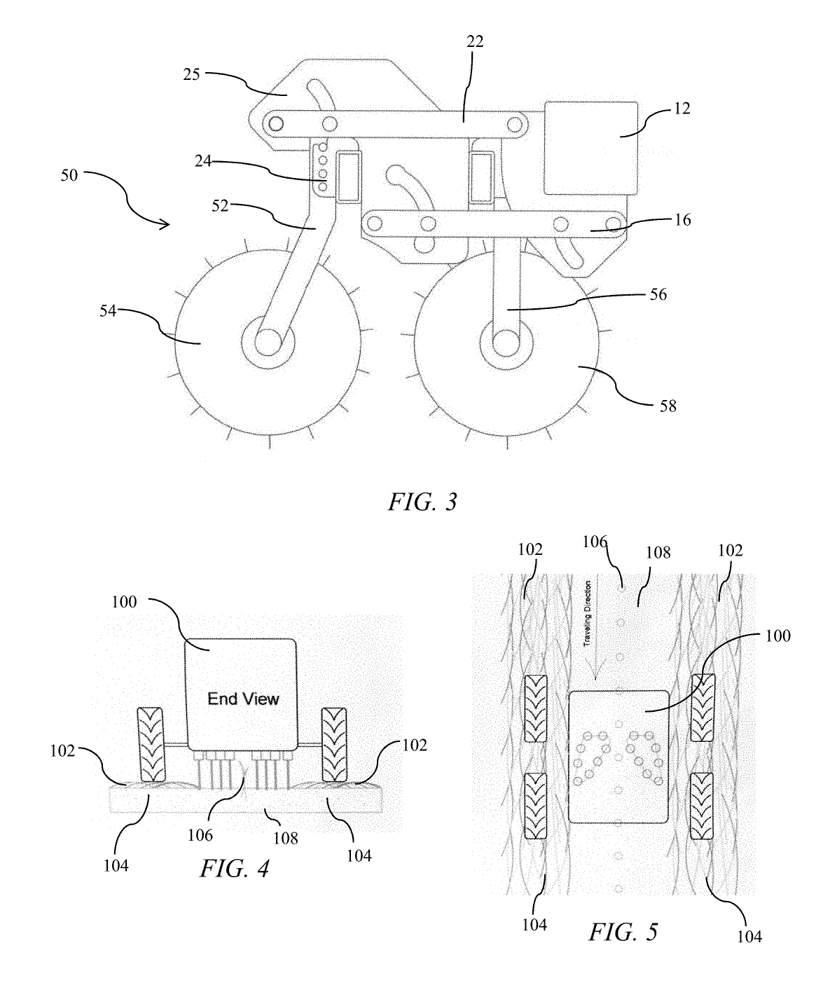

Moreover, the frame 10 may contain a second agricultural tool 50 such as one or more roller crimpers for terminating a cover crop, as illustrated in FIG. 3. The second agricultural tool 50 may be disposed over other sections of the length of the frame in other tool connection locations 14, such as between the sections of the length of the frame where the first agricultural tool may be disposed. Therefore, the frame preferably has first and second agricultural tools disposed side-by-side along portions of the length of the frame 10 so that the first and second agricultural tools may be pulled behind a tractor or other vehicle to manage both the rows of cover crop and rows of cash crop in the field at the same time.

The second agricultural tool 50 may extend from the connection plate 24 via first extension stem 52 and/or second extension stem 56. As illustrated in FIG. 3, first extension stem 52 has first roller crimper 54 attached thereto, and second extension stem 56 has second roller crimper 58 attached thereto. Each of these may be in alignment with each other, or may be staggered to provide further width of crimping for terminating a cover crop, as desired.

The agricultural tools may comprise, as noted above, crop management, soil management, and seeding applications. Tillage coulters may be utilized to loosen compacted soil in anticipation for seeding, and seeding coulters or disc openers may be utilized to loosen soil and plant seeds within various rows. Both the tillage and seeding coulters typically include series of disc blades spaced in increments that are based on the specific widths of the rows of the desired crop and the distance between the rows. The number of disc blades may typically range from 2 to 6 and the distance between the discs may typically range from between 3″ to 10″. The disc blades may preferably turn in the same direction as the wheels or tracks of the tow vehicle, and may closely follow the path of that machine. The diameter of the rigid blades may be approximately 16″ with a pattern cut in the center to accept a steel shaft. The steel shaft may accept spacers between the blades and may be mounted to an end plate with a flange that houses a bearing. The disc blades, spacers and shaft may all turn in the same direction when in use. Allowing shaft rotating while reducing friction, a roller bearing may accept the steel shaft and mount to a plate. The plates may have holes for connection of parallel linkages that may permit the disc blade assembly to travel up and down, such as over the particular contours of the field. At the frame, the parallel linkage may connect in a similar fashion to its opposing end. In an embodiment, the parallel linkage is where the blades may be removed and other components may be added, as desired.

Depth managers will be present on all applications that engage the soil. A depth manager can be independently attached to the connection point (shown as 24 in the drawings), or incorporated into the perspective tool (shown as 30 in FIG. 2). Depth managers may include a ski, a wheel, or a track, so that the depth of the tillage or seeding coulters may be controlled. In a preferred embodiment, the depth manager may be a wheel that may be moved up and/or down in, for example, ¼″ increments using a series of staggered holes that may accept ½″ bolts. If the depth manager is a ski, the portion of the ski that contacts the ground may preferably be about 4″ wide, although the size should not be limited, and a wear pad that may be made from a friction-reducing material, such as Teflon® or polyurethane may further be utilized.

Seeding may further be accomplished with a seeding tube that may feed a seed tube from a seed box for depositing seeds within rows created by disc opener, seeding coulters or the like. Specifically, the seed-tube may be positioned beside or behind seeding coulters for planting the same in the soil. Attached to the seed tube may be a polyurethane or Teflon seed deflector that may improve the seeds' contact with the soil.

With respect to roller crimper tools, a roller crimper may be utilized in the path of cover crop seeding operations, but not over cash crop seeding operations. A hollow cylinder may be attached to stem 25, taking the place of previous tools and positioned to roll over the rows of cover crops while maintaining separation from the rows of cash crops planted side-by-side. Typical roller crimper cylinders may be approximately 16″ in diameter, with total width equal to or greater than the cover crop seeded area. Fixed blades may be evenly spaced around the cylinder in a helical or chevron arrangement, although any arrangement may be utilized and the present invention should not be limited as described herein. Typically, the blades may have a blunt edge to crimp or pinch the stems of the cover crop, thus terminating the cover crop. The blades may be spaced so no less than two blades contact a plant at one time. The crimper tools may extend over partial portions of the frame and may be combined with other tools, applicators for fertilizing and/or other specialized tools so that parts of a field may be crimped and other parts of the field may be fertilized, for example. Alternatively, the crimper tools may extend over the entirety of the frame, but may be offset from each other to provide overlapping coverage when rolled over a field, thereby aiding in crimping the crops on the field.

Additional functionality may further be incorporated into roller crimpers. For example, a finger weeder may be utilized and applied to a cash crop as a roller crimper terminates a cover crop inter row. Specifically, cutting coulters may be mounted on each side of the roller crimper, and on opposite sides of the cutting coulters may be mounted finger weeders. The cutting coulter may trim the edges of the cash crop providing clear access for the finger weeders to weed the cash crop at the same time.

Moreover, roller crimpers may be designed and utilized so that they cover only parts or portions of cover crops inter row. This may be desirable where a plurality of cover crops are planted in the inter row between cash crops. For example, multiple cover crops may be planted inter row in a configuration that optimizes performance and resource concerns. For example, oat may be planted inter row along with cereal rye, which may be planted in the innermost portion of the cover crop band (i.e., closest to the cash crop). The oat, when planted in the inter row, may be advantageous in promoting weed suppression while reducing soil compaction, while the cereal rye along the innermost portion of the cover crop band may be integral to weed and water management of the cash crop. Therefore, roller crimpers may be designed to terminate only a portion of the cover crops in the inter row, such as the oat, for example, while maintaining the growth of the cereal rye, which may naturally die later in the summertime when temperatures increases and canopy of the cash crop shades it out.

In an embodiment of the present invention, the apparatuses and methods described herein may also be utilized by and/or performed by autonomous robots and/or small autonomous tractors or other lightweight machines. These lightweight machines may be utilized to navigate through fields where larger tractors cannot, which may improve timely applications to cover and/or cash crops. In an exemplary embodiment, cover crop termination may be useful for the lightweight machines that may normally find it difficult to navigate agricultural fields, such as fields that are saturated or muddy. Specifically, cover crop termination may provide important pathways for the lightweight machines to travel for tending to cash crops.

For example, a cover crop may be planted between rows of cash crops. The cover crops may be utilized to provide numerous benefits, as disclosed above, including, for example, weed suppression, nutrient fixing, reduction of soil compaction, etc. When terminated, the cover crops may provide a mat over the soil that may be ideally suited for the wheels of the lightweight machines, which may use the terminated cover crops for traction as the lightweight machines tend to the cash crop. The terminated cover crop may be useful in that it may provide a relatively smooth path free of water and mud, without obstructions, allowing for easy rolling of the lightweight machines thereover that may tend to the cash crops. By providing lightweight machines access to cash crop rows utilizing cover crop rows for travel, the lightweight machines may provide functions to the cash crop not otherwise available.

Specifically, where the cover crop rows are the same width as the cash crop rows, the wheels of the lightweight machines may traverse over the cover crop-generated pathways, straddling the cash crop therebetween, allowing the lightweight machines to gain direct access to the cash crop for weeding, application of fertilizers and the like, or for other purposes.

In addition, the machines may also be relatively heavier units, and may be equipped with roller crimpers themselves so that as they traverse over the cover crop, they may terminate the same thereby providing the pathways for their own traversal, and providing access to the cash crops as needed.

A residue manager section may be utilized to manage soil residue in the tilled soils, and to otherwise clear debris from the seed rows. The residue manager gang may include a residue manager that may include a plurality of angled blades that may be directed to seed rows to remove debris therefrom.

Another tool that may be disposed on the frame may be a torch for flaming cover crops or weeds within cash crop bands when conditions require, such as when cover crops or weeds within cash crop bands are particularly hearty or difficult to terminate based on crimping alone. A torch, sized and pressurized specifically for the cover crop or weed of interest, may be disposed on the frame, and may be utilized in conjunction with crimping with attached roller crimpers. Specifically, the torch or plurality of torches may be attached to the end plate that may be attached to the parallel arms. Torch adjustment may be vertical, horizontal, or may be angled in any direction as desired.

Heavy smooth rollers or skis may further be used, such as in conjunction with one or more torches, wherein the smooth rollers may be heated by the torches and may aid in terminating a cover crop or weeds in anticipation of the planting of a cash crop.

Herbicides, fertilizers, fungicides and insecticides may also be utilized in conjunction with one or more tools as disclosed herein. Specifically, the herbicides, fertilizers fungicides and/or insecticides may be applied together with, for example, a crimping tool, and may aid in terminating cover crops and/or weeds, and further may be utilized to condition soils in anticipation of planting of cash crops or the like.

The following describes various embodiments of the present invention, describing exemplary arrangements of various modules that may be adopted on a frame for utilization in zonal farming, such as in alternate rows of cover crops and cash crops, for example.

Specifically, an embodiment of the present invention may be utilized for fall cover crop seeding but including a cash crop tillage coulter. More specifically, the embodiment may include a section comprising a double disc opener for a cover crop and a section comprising a tillage coulter for a cash crop, disposed side-by-side on a frame. A residue manager may be incorporated adjacent to, and namely in front of, a disc opener or seed coulter section for the cover crop to thereby clear the seed rows for planting therein. It should be noted that a plurality of disc openers, seed openers or tillage coulters may be installed in a configuration that maximizes function and maintains clearance

Moreover, an embodiment of the present invention may be utilized for spring/summer cover crop termination and cash crop weed management using a rotary hoe. In a first section, a crimping wheel may be disposed for crimping and terminating a cover crop, and in a second section, a rotary hoe may be disposed for weed management and soil conditioning for a cash crop. The rotary hoe may be particularly useful for crusted and heavily compacted soils to loosen the same. A residue manager may be utilized in front of the rotary hoe for clearing debris within seed rows for the cash crop before the cash crop has been planted.

In addition, an embodiment of the present invention may be utilized for spring pre-plant cash crop band tillage using a section comprising a plurality of tillage coulter blades for a cash crop behind a Residue Manager section for clearing debris. A hydraulic cylinder may be utilized for moving the tillage coulter blades into and out of the soil, and to select particular depths for the tillage coulter blades, as desired. The hydraulic cylinder's main function is to apply a downward force to the section to maintain depth. The cylinder may be used for many tool different functions, and its pressure may be changed from application to application. The use of springs or tension steel may also create the same or similar downward pressure effect. To limit depth, a depth manager, such gauge wheels or skis may be utilized. For roller crimping, as described herein, the depth manage may not be necessary as the roller crimper itself limits depth.

Further, an embodiment of the present invention may be utilized for flame weeding of a cash crop, such as during pre-plant of the cash crop. Specifically, in a first section may be a crimping wheel that may be utilized to terminate a cover crop, and disposed beside the crimping wheel may be a flame weeder for particularly difficult weeds that may not terminate using the crimping wheel itself. The flame weeder may send a flame, fed by a tank of fuel, downwardly to scorch the weeds and/or the cover crop to aid in terminating the same. A Residue Manager section may be in front of the flame weeder and may be utilized to clear debris out of the way for the flame weeder.

Still further, an embodiment of the present invention may be utilized to impart additional functionality on the various embodiments described herein, namely to aid in terminating difficult weeds or cover crops using a flame weeder, as described above. Specifically, embodiments incorporating a heavy roller may roll over and crush scorched weeds and/or cover crops that have been scorched via the flame weeder element. Preferably, the roller may also be heated and may improve the efficiency of termination of the weeds and/or cover crops.

In addition, an embodiment of the present invention may be utilized for applying herbicide, fertilizer, fungicide, insecticide, or other like liquid element with a cover crop crimping tool. Specifically, a first section comprising a crimping wheel may be provided for crimping and terminating a cover crop, and a second section may include an herbicide or fertilizer applicator disposed side-by-side for spraying herbicide, fertilizer, fungicide, insecticide, or other like liquid elements to the soil, especially in a cash crop zone. A residue manager may be utilized to clear debris from seed rows therein and optimize the soil for seeding the same. A spray hood may be utilized to minimize drift of sprays onto non-target areas.

Moreover, other components may be incorporated into the present invention. A first section comprising a plurality of disc opener or seed coulter blades for a cover crop and a second section comprising a seed tube for the cover crop in a cover crop zone may be utilized. A seed coulter section comprising a scraper for scraping dirt and organic plant material from the seed coulter blades may also be utilized. A further residue manager may be utilized for clearing debris from seed rows, especially prior to planting seeds within the seed rows.

The various embodiments as disclosed herein may be utilized and swapped depending on the desired usage thereof, but especially in side-by-side zonal planting and/or termination of cover crops and cash crops, as desired. The various components are modular and may be included together on a single frame, but may be removed and replaced from a connection point as desired.

FIGS. 4-5 illustrate an end view and a plan view, respectively, of a representation of a lightweight machine 100 using pathways formed by a terminated cover crop, such as by roller crimper or the like, as described herein. The wheels 112 of the lightweight machine 100 may travel over the terminated cover crop 114, which may have been terminated using the apparatuses described herein, or via the same or another lightweight machine. The lightweight machine 100 may further include weeders 116 on an underside thereof that may suppress weeds adjacent a cash crop 118.

### Example 1

In a preferred example of the present invention, organic soybean may be utilized as a cash crop with mechanical cover crop termination, as follows. Specifically, after harvest of a cash crop, cool season grasses such as cereal rye or another biennial small grain may be fall-seeded in the future cover crop bands using the modular apparatuses described herein and/or utilizing robotic technology, thereby providing the advantages specific to the use of cover crops as described herein, including, specifically, for weed suppression by creating competition for space, nutrients and light, growing biomass (to be crimped at flowering), and releasing natural weed suppressive chemicals (allelopathy). The small grain survives the winter and comes out of dormancy the following spring. Other inter row cover crops may be spring-seeded in the remaining inter-rows for other soybean needs. The modular apparatuses of the present invention would be moved from the cereal rye locations to the remaining inter-rows that may include spring oats, a cool season grass, mustard, and/or a cool season brassica. The oat may have similar functions as the cereal rye, but may be crimped at a later date providing a staggered allelopathic event. The mustard may be managed as a biofumigation crop for general nematicidal purposes and may thereafter be crimped with the oat. Using the modular apparatuses of the present invention, crimping cereal rye would likely occur first. The modular crimping apparatuses described herein would be removed or shifted, and modular crimping apparatuses necessary for the oat/mustard blend would be installed. The soybean continues to grow without competition or benefit of the inter-row cover crops.

### Example 2

In another exemplary example of the present invention, a two season cropping rotating may utilize the apparatuses and methods described herein for providing cash and cover crops. Specifically, in late winter or early spring, a cover crop of white clover may be planted in inter-row bands, between cash crop rows that will be utilized to grow soybeans later in the first growing season and corn in the second growing season. Specifically, in the first growing season, soybeans are seeded in the cash crop band, and band applications of fertilizer and herbicide are applied in the cash crop band. Soybeans thereafter drop their leaves, and the white clover continues to grow. Soybeans are then harvested, and the white clover over winters. The white clover comes out of dormancy in the spring of season two, and corn is planted in the same location as the previous season's soybeans in the cash crop band. The corn is managed with cash crop band applications of fertilizer and herbicide, leaving the inter-row cover crop of white clover untouched. The white clover acts as a “living mulch,” which is maintained through the growing seasons. The inter-row use of the white clover reduces erosion, improves water quality, and reduces the need for herbicides. The agricultural apparatus utilized for maintaining the cash and cover crop bands may utilize residue managers in the cover crop band for removing debris to improve the positions of the seeds. The residue managers may also be utilized in the cash crop band to remove debris so herbicides and fertilizers are placed directly on the soil. Spray hoods may also be utilized to minimize drift and/or protect the cover crop.

### Example 3

In another example of the present invention, organic corn may be utilized as a cash crop with mechanical cover crop termination, as follows. Specifically, after harvest of a cash crop, cool season species such as a mix of hairy vetch and triticale may be fall-seeded in the future inter-rows to meet the nutrient needs of the future corn crop in the cash crop rows. The hairy vetch and triticale typically survive the winter and come out of dormancy the following spring. The cash crop band may be fertilized and prepared with a modular apparatus, as described herein, consisting of tillage coulters, roto-tilling and/or under-cutting with a cultivator sweep. The cash crop band may alternatively be left undisturbed for a no-till environment. Corn may be planted in the cash crop band, and the inter-row may be crimped. A finger weeder or small mower may be installed next to the crimper that may be used to remove weeds that are located in the cash crop band. Alternatively, lightweight machines may utilize the terminated cover crop bands for removal of weeds or for collecting data from the early growth of the cash crop.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are non-limiting, and it should be noted that claim limitations presented herein are not meant to describe the invention as a whole. Moreover, the invention illustratively disclosed herein suitably may be practiced in the absence of any element which is not specifically disclosed herein.

I claim:

1. An agricultural apparatus used for managing both a cover crop and a cash crop at the same time comprises:
a frame running perpendicular to a direction of travel of a tow vehicle, wherein the frame is configured to be attached to the tow vehicle when in use, the frame further comprising a main tool frame, and a set of parallel arms extending from the main tool frame, and a first assembly attached between the parallel arms, the first assembly comprising a plurality of tool connection locations;
a first agricultural tool mounted to the frame at a first tool connection location, the first agricultural tool configured to manage a cover crop row in a field; and
a second agricultural tool mounted to the frame at a second tool connection location, the second agricultural tool configured to manage a cash crop row in the field, wherein the cash crop row is adjacent the cover crop row.

2. The agricultural apparatus of claim 1 wherein the parallel arms are configured to travel vertically.

3. The agricultural apparatus of claim 1 further comprising a second assembly attached between the parallel arms, the second assembly comprising additional tool connection locations.

4. The agricultural apparatus of claim 1 wherein the first agricultural tool comprises a V-shaped double disc opener.

5. The agricultural apparatus of claim 1 wherein the first agricultural tool comprises a roller crimper.

6. The agricultural apparatus of claim 1 wherein the first agricultural tool comprises a V-shaped double disc opener and the second agricultural tool comprises a roller crimper.

7. A method of planting cover crops in cover crop rows and cash crops in cash crop rows comprising the steps of:
planting a cover crop in a plurality of cover crop rows; and
simultaneously terminating the cover crop in the cover crop rows and seeding a cash crop in the cash crop rows using the agricultural apparatus of claim 1.

8. An agricultural apparatus used for managing both a cover crop and a cash crop comprising:
a frame running perpendicular to a direction of travel of a tow vehicle, wherein the frame is configured to be attached to the tow vehicle when in use, the frame further comprising a first agricultural tool comprising a series of double disc openers removably connected to a frame, wherein the first agricultural tool is configured to be removed and replaced with a second agricultural tool.

9. The agricultural apparatus of claim 8 wherein first agricultural tool comprises a V-shaped double disc opener.

10. The agricultural apparatus of claim 8 wherein the first agricultural tool comprises a roller crimper.

11. The agricultural apparatus of claim 9 wherein the first agricultural tool comprises a depth manager for maintaining a depth of blades of the V-shaped double disc opener.

12. The agricultural apparatus of claim 8 further comprising:

13. The agricultural apparatus of claim 8 wherein the first agricultural tool comprises a V-shaped double disc opener and the second agricultural tool comprises a roller crimper.

14. A method of planting cover crops in cover crop rows and cash crops in cash crop rows comprising the steps of:
planting a cover crop in a plurality of cover crop rows using the agricultural apparatus of claim 8, wherein the first agricultural tool comprises a V-shaped double disc opener;
removing the first agricultural tool from the frame at a tool connection location;
adding the second agricultural tool to the frame to the tool connection location, wherein the second agricultural tool comprises a roller crimper; and
terminating the cover crop in the cover crop rows using the roller crimper.

15. A method of using lightweight machines to tend to crops in an agricultural field, the method comprising the steps of:
planting at least one cover crop in a plurality of cover crop rows;
planting at least one cash crop in a plurality of cash crop rows;
terminating the cover crop by crimping the cover crop with a roller crimper while simultaneously leaving the cash crop untouched; and
tending the cash crop with at least one lightweight machine, wherein the lightweight machine uses the crimped cover crop in the cover crop rows as pathways for traveling thereover.

16. The method of claim 15 wherein the cover crop is terminated via the roller crimper attached to the lightweight machine.

17. The method of claim 15 wherein the lightweight machine comprises a first roller crimper on a first side thereof and a second roller crimper on a second side thereof.

18. The method of claim 15 wherein the lightweight machine straddles the cash crop row by traveling on adjacent cover crop rows.

19. The method of claim 18 wherein the lightweight machine comprises a first wheel on a first side thereof and a second wheel on a second side thereof, wherein the first wheel travels over a first cover crop row adjacent a cash crop row on a first side of the cash crop row, and the second wheel travels over a second cover crop row adjacent the cash crop row on a second side of the cash crop row.

20. The method of claim 15 wherein the lightweight machine comprises at least one tool for tending to the cash crop in the cash crop rows.
